(19) United States
(12) Patent Application Publication
(10) Pub. No.: US 2004/0092351 A1
(43) Pub. Date: May 13, 2004

(54) Rubber cushioned chain tensioner

(75) Inventor: Ron Bergman, Mclntosh, MN (US)

Correspondence Address: MERCHANT & GOULD PC, P.O. BOX 2903, MINNEAPOLIS, MN, 55402-0903, US

(73) Assignee: Arctic Cat, Inc., Thief River Falls, MN (US)

(21) Appl. No.: 10/291,149

(22) Filed: Nov. 7, 2002

(51) Int. Cl. F16H 7/12; F16H 7/08

(52) U.S. Cl. 474/140; 474/111; 474/136

(57) ABSTRACT

A chain and sprocket mechanism having a first sprocket, a second sprocket, and a chain engaged with the first and second sprockets, such that rotating the first sprocket moves the second sprocket via the chain. A tensioner is engaged with the chain between the first and second sprockets so as to apply tension to the chain. The tensioner is at least partly made of an elastic material, such as rubber or flexible plastic. The flexible material isolates the tensioner from vibrations, cushioning the tensioner and inhibiting the conduction of vibrations such as engine noise through the chain and the tensioner. The tensioner may be made partially or entirely of elastic material. The tensioner may be adjustable in a linear motion, to adjust the tension in the chain. The tensioning mechanism may be made so as to be mechanically simple, using translational motion only, without pivotal motion. The tensioning mechanism also may be functional without the use of springs or other elastic structures.

### BACKGROUND OF THE INVENTION

1. Field of the Invention

The invention relates to a chain and sprocket mechanism and a device for tensioning the chain therein. More particularly, the invention relates to a tensioner cushioned with elastic material, for tensioning the chain in a chain and sprocket mechanism. The invention also relates to a method for tensioning a chain, and to a method of reducing noise from a chain and sprocket mechanism.

2. Description of Related Art

A wide variety of devices use chain and sprocket mechanisms to transfer motion from one moving component to another. In conventional chain and sprocket mechanisms, two or more sprockets are connected with a closed loop of chain. As one sprocket turns, it causes the chain to move, which in turn causes the other sprocket to turn.

However, in order for a chain and sprocket mechanisms to operate properly, the chain typically must be placed under tension. Otherwise, the mechanism may malfunction, i.e. the chain may slip against one or both sprockets rather than transmitting the motion of one to the other, the chain may slide completely off of one or both sprockets, etc.

For some applications, it is possible to construct the chain to the precise length needed, so that it is under tension by virtue of its size. However, for many applications, this is unsuitable. Chains attached in such a fashion cannot be readily removed when performing routine maintenance, repairing, or replacing components of the chain and sprocket mechanism. In addition, components of the chain and sprocket mechanism may undergo changes with normal wear, such as a gradual lengthening of the chain. In such a case, the chain tension also changes. If the chain and sprocket mechanism does not include some means of adjusting the tension, it may not be possible to compensate for such changes.

Alternatively, in some applications, it is possible to move one or both of the sprockets, so as to change the tension in the chain by changing the distance between sprockets. However, in many applications, particularly those involving large or heavy motorized equipment, such a solution is impossible or impractical. Even when it is possible to make the sprockets movable, the changes required to facilitate the necessary motions may make the assembly heavier, less durable, or more difficult to produce and maintain.

For this reason, in many chain and sprocket mechanisms it is conventional to use a chain tensioner. Conventional chain tensioners vary somewhat in structure, but essentially consist of a solid roller or block of metal, or another similarly rigid material that can be pressed against the chain to change its total path length. As the chain's path length changes, the tension in the chain changes. In this way, an appropriate degree of tension can be maintained.

Conventional chain tensioners have disadvantages, however.

First, both conventional chains and the rigid material of the tensioner transmit vibrations easily. Thus vibrations from the sprockets, the devices to which the sprockets are attached, and even the chain itself are readily transmitted from place to place, i.e. from one sprocket to another, through the chain, the tensioner, and conventional mechanisms used to adjust the tension.. In addition, even the contact of the chain with the tensioner itself can produce vibrations, and these vibrations also can be transmitted into other structures.

Generating and transmitting vibrations in this fashion may be undesirable for a variety of reasons, i.e. they may contribute to the total noise output of the chain and sprocket mechanism and/or the device(s) to which it is connected.

Also, tensioners conventionally are made so as to change the path length of the chain by rotating. For example, a pivot point is defined off-center in the tensioner, so that as the tensioner rotates the distance by which the chain must divert to pass around it increases or decreases.

However, such an off-center rotating tensioner arrangement may require a relatively complex mechanism. Conventional tensioners typically require multiple moving parts, and interlocking mechanisms such as catches and pins. In addition, conventional tensioners also typically require one or more springs or other elastic structures, in order to provide biasing and other functions. As a result, conventional tensioners may be relatively heavy, prone to malfunction or wear, or difficult and expensive to produce and maintain.

### SUMMARY OF THE INVENTION

It is the purpose of the claimed invention to overcome these difficulties, thereby providing a chain tensioner that resists transmission and/or generation of vibrations, and a sprocket and chain mechanism with such a tensioner. It is also the purpose of the claimed invention to provide a method for tensioning a chain and a method of reducing vibration within a chain and sprocket mechanism. It is further the purpose of this invention to provide a simple, reliable, inexpensive tensioning mechanism for tensioning a chain in a sprocket and chain mechanism.

An exemplary embodiment of a chain and sprocket mechanism in accordance with the principles of the claimed invention includes a first sprocket and a second sprocket, with a chain engaged with the first and second sprockets, such that rotating said first sprocket moves the chain, which in turn moves the second sprocket. A tensioner is engaged with the chain between the first and second sprockets so as to apply tension to the chain.

The tensioner is at least partly made of an elastic material, such as rubber. In some embodiments, the tensioner may be made entirely of elastic material. In other embodiments, only a portion of the tensioner may be made of elastic material.

The tensioner, being at least partly made of elastic material, is adapted to absorb vibrations in the chain. In this way, the transmission of vibrations from one structure to another through the chain and the tensioner is inhibited.

Thus, unwanted vibrations traveling from one portion to another of a device with a chain and sprocket mechanism according to the claimed invention therein may be reduced. In particular, noise from one system to another is inhibited from traveling through the chain and sprocket mechanism via the chain and/or the tensioner. For example, in a motorized vehicle such as a snowmobile, motion from the engine may be passed through the sprocket and chain mechanism of the claimed invention, while engine noise does not easily pass from the engine through the sprocket and chain mechanism to the chassis, the vehicle operator, etc.

The tensioner may be adjustable so as to vary the tension in the chain. In particular, the tensioner may be adjustable in a translating motion.

An exemplary embodiment of a tension mechanism for tensioning a chain engaged with first and second sprockets in accordance with the principles of the claimed invention includes a tensioner adapted to engage a chain so as to apply tension thereto. A support is engaged with the tensioner so as to support said tensioner, and to restrict tensioner to translational motions. The tension mechanism also includes a tension adjustor engaged with the tensioner. The tension adjustor is moveable so as to cause the tensioner to translate as the tension adjustor moves.

In addition, because the tensioner is made at least in part of elastic material, it is adapted to accommodate small changes in the physical configuration of a chain and sprocket mechanism without external adjustment. That is, elastic material being “springy” and deformable, the tensioner adapts to changes in the chain and sprocket mechanism by expanding or compressing to maintain engagement with the chain, instead of losing engagement with the chain, as would a rigid tensioner.

Thus, the tensioner can maintain proper tension in the event of changes in the chain and sprocket mechanism, even without the need to manipulate the tension adjustor.

### BRIEF DESCRIPTION OF THE DRAWING

Like reference numbers generally indicate corresponding elements in the figures.

FIG. 1 is a schematic view of an exemplary embodiment of a chain and sprocket mechanism incorporating a tensioner in accordance with the principles of the claimed invention.

FIGS. 2A and 2B are schematic views of the chain and sprocket mechanism of FIG. 1 showing the tensioner in different positions.

FIGS. 3A and 3B show two views of an exemplary embodiment of a tensioner in accordance with the principles of the claimed invention.

FIGS. 4A and 4B show two views of another exemplary embodiment of a tensioner in accordance with the principles of the claimed invention.

FIGS. 5A and 5B show two views of yet another exemplary embodiment of a tensioner in accordance with the principles of the claimed invention.

FIG. 6 shows a perspective illustration of a portion of an exemplary case for a chain and sprocket mechanism in accordance with the principles of the claimed invention.

FIG. 7 shows a perspective illustration of another portion of the case of FIG. 6.

### DETAILED DESCRIPTION OF THE PREFERRED EMBODIMENT

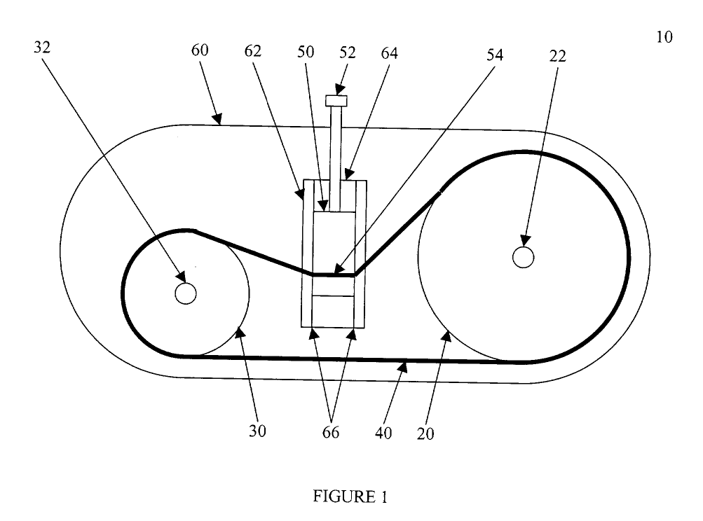

Referring to FIG. 1, a sprocket and chain mechanism 10 in accordance with the principles of the claimed invention includes a first sprocket 20 and a second sprocket 30. A chain 40 is in communication with the first and second sprockets 20 and 30, such that motion of one of the first and second sprockets 20 and 30 causes the chain 40 to move, which in turn causes the other of the first and second sprockets 20 and 30 to move.

As illustrated in FIG. 1, the second sprocket 30 is smaller than the first sprocket 20. Thus, the embodiment illustrated would proved a drop in sprocket ratio between the first and second sprockets 20 and 30. However, this is exemplary only. The first sprocket 20 may be larger than, the same size as, or smaller than the second sprocket 30.

The first sprocket 20 may include a first sprocket connection 22 for engaging another component, so that the first sprocket 20 and the component engaged therewith move together. As illustrated, the first sprocket connection 22 is an axial aperture, which might for example be suitable for engagement with a rotating shaft. However, this is exemplary only, and other first sprocket connections 22 may be suitable for use with the claimed invention. Furthermore, particular first sprocket connections 22 need not be axially located as illustrated, and may be suitable for engagement with devices components other than a rotating shaft.

The second sprocket 30 similarly may include a second sprocket connection 32 for engaging another component, so that the second sprocket 30 and the component engaged therewith move together. As illustrated, the second sprocket connection 32 is an axial aperture, which might for example be suitable for engagement with a rotating shaft. However, as with the first sprocket connection 22, this is exemplary only.

It is noted that the terms “sprockets” and “chain” are used broadly with regard to this invention. Likewise, the sprockets 20 and 30 and chain 40 are illustrated schematically in FIG. 1, rather than in detail.

Essentially, any rotatable structure that is adapted to engage a chain 40 in the manner described herein may be suitable for use as a first sprocket 20 or second sprocket 30. Although the sprockets 20 and 30 may include teeth (not shown) for engaging the chain 40, this is exemplary only, and the sprockets 20 and 30 may engage the chain 40 in some other fashion.

Similarly, any sufficiently moveable and flexible structure that is adapted to engage the sprockets 20 and 30 in the manner described herein may be suitable for use as a chain 40. Although the chain 40 may be constructed of individually moveable links (not shown) to provide flexibility and to engage the sprockets 20 and 30, this is exemplary only, and the chain 40 may be made flexible and may engage the sprockets 20 and 30 in some other fashion.

Thus, a wide variety of sprockets 20 and 30 and chains 40 made from a wide variety of materials may be suitable for use with the claimed invention. Sprockets and chains are well known, and are not further described herein.

The sprocket and chain mechanism also includes a tensioner 50. The tensioner 50 is engaged with the chain 40 and is disposed between the first and second sprockets 20 and 30.

As illustrated in FIG. 1, the tensioner 50 changes the shape of the path followed by the chain 40. Moving the tensioner 50 thus causes the path length of the chain 40 to increase or decrease, and as a result increases or decreases tension within the chain 40. The tensioner 50 engages the chain 40 at a contact area 54.

At least a portion of the tensioner 50 is made of an elastic material. Unlike more rigid materials such as metal or hard plastic, the elastic material deforms when exposed to vibrations, damping them and inhibiting their travel through the tensioner 50 and the chain 40.

Thus, the elastic material of the tensioner 50 provides a cushioning effect. Vibrations that are transferred from the chain 40 to the tensioner 50 may be absorbed, rather than transferred via the chain 40, tensioner 50, adjustor 52, and supports 62 (see below for 50 and 62) to other structures. For example, in an exemplary embodiment wherein the first sprocket 20 is connected to the shaft of a vehicle engine, engine vibration, including audible noise, is inhibited from being carried by the chain 40 to the second sprocket 30, where it might travel further throughout the vehicle.

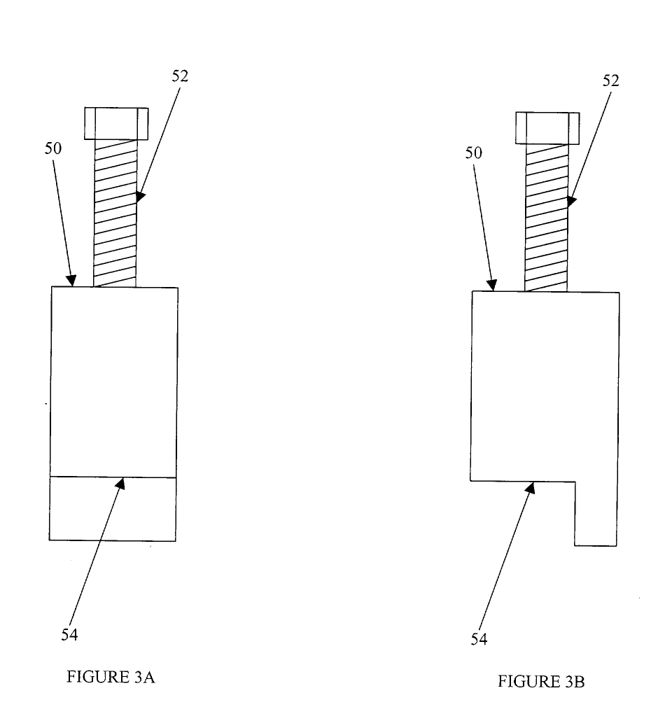

Exemplary embodiments of a chain tensioner 50 in accordance with the principles of the claimed invention are illustrated in FIGS. 3, 4, and 5.

The distinction between an elastic material, as used in the tensioner 50 of the claimed invention, and an elastic structure, is emphasized.

An elastic material is one such as rubber, some soft plastics, etc., which is deformable, but tends to return to its original shape. Elastic materials are elastic by virtue of their material properties, chemical composition, etc..

In contrast, an elastic structure, such as a spring, is elastic because of its overall structure, or shape. Although springs may be referred to in common parlance as elastic, springs commonly are made of materials which overall are essentially rigid, such as metals or hard plastics. It is only when they are formed into special structures that these materials cease to be rigid, and instead perform elastically. Thus, springs are not elastic materials insofar as this application is concerned, but rather are considered structures.

For purposes of this application, an elastic material is one that is elastic regardless of its shape. Elastic materials may be used in what could be termed “bulk” applications, i.e. as a slug, block, cylinder, tube, torus (i.e. an o-ring), etc. of material, without concern to the particular shape. This is not to imply that elastic materials have no physical structure, or that they must be solid; certain flexible foams, which may consist of a lattice of bubbles or films with numerous voids therein, may be suitable for use as elastic materials.

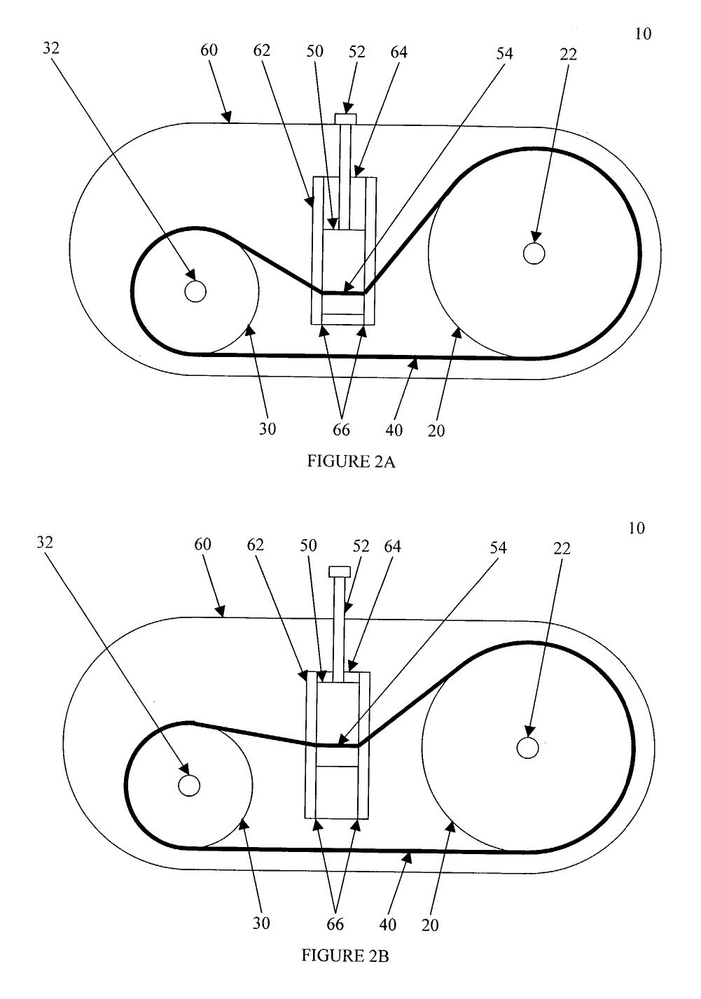

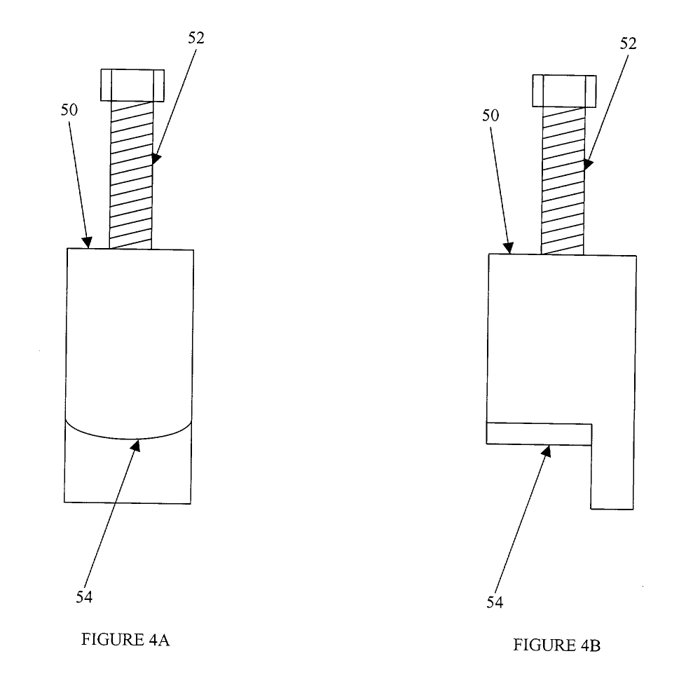

As shown in FIGS. 3A, 3B, 4A, and 4B, and likewise in FIGS. 1 and 2, the tensioner 50 is a single piece of material. Thus, in those embodiments, the entire tensioner 50 is made of elastic material. However, this is exemplary only.

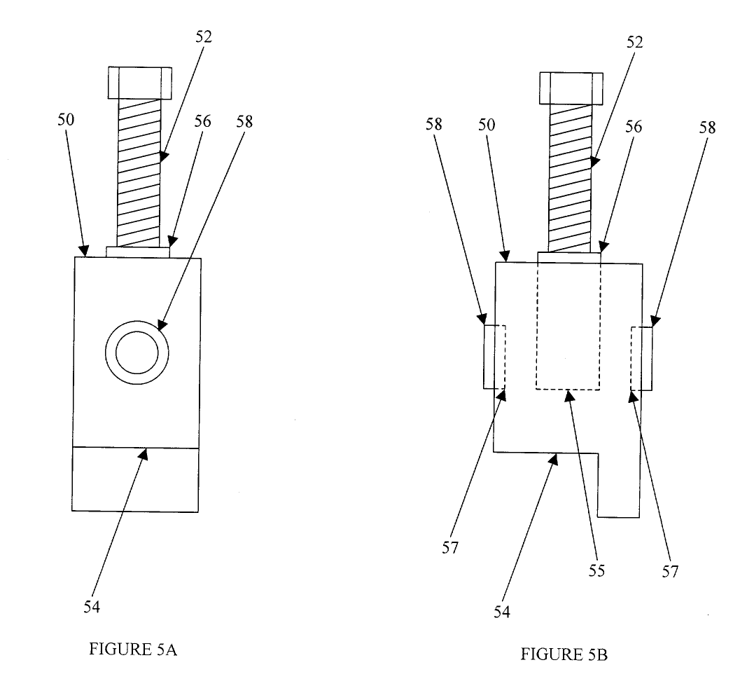

FIGS. 5A and 5B, for example, show an embodiment with an elastic portion 56, and elastic portions 58.

As illustrated in FIG. 5B, the elastic portion 56 is a plug of elastic material that extends into a cavity 55 in the tensioner 50. As shown, the adjustor 52 (see below) engages the elastic portion 56. The elastic portion 56 thus provides the cushioning effect described above, isolating the tensioner 50 from vibrations, and thus inhibiting the passage of vibrations through the chain 40, the tensioner 50, and the tension adjustor 52 (see below).

Also as illustrated in FIG. 5B, the elastic portions 58 are o-rings of elastic material that are set into cavities 57 in the tensioner 50. In the configuration shown, the elastic portions 58 would engage the support 62 (see below) when the tensioner 50 is used in the arrangement shown in FIGS. 1, 2A, and 2B. In such an arrangement, the elastic portions 58 thus also contributes to the cushioning effect described above, isolating the tensioner 50 from vibrations to and from the guide 62 (see below).

In an embodiment with elastic portions 56 and/or 58, the remainder of the tensioner 50 may be made of another material or materials. For example, some or all of the tensioner 50 might be made of metal, hard plastic, or some other rigid material, in order to provide good wear resistance between the contact area 54 and the chain 40.

In embodiments wherein the tensioner 50 has an elastic portion 56, the shape and arrangement of the elastic portion 56 may vary considerably. As shown in FIGS. 5A and 5B, the elastic portion 56 is a cylindrical plug that fits into a cavity 55 in the tensioner 50. However, this is exemplary only. Other shapes for and arrangements of the elastic portion 56 may be equally suitable.

Likewise, in embodiments wherein the tensioner 50 has elastic portions 58, the shape and arrangement of the elastic portions 58 may vary considerably. As shown in FIGS. 5A and 5B, the elastic portions 58 are o-rings that fit into cavities 57 in the tensioner 50. However, this is exemplary only. Other shapes for and arrangements of the elastic portions 58 may be equally suitable.

A variety of materials may be suitable for use as the elastic material, whether the entire tensioner 50 or only a portion 56 of it is made thereof. Suitable materials include, but are not limited to, rubber and flexible plastic.

Similarly, in embodiments wherein only a portion 56 of the tensioner 50 is made of elastic material, a wide variety of materials may be suitable for use in the remainder of the tensioner 50. Suitable materials include, but are not limited to, metal and rigid plastic.

It is noted that even when the tensioner 50 is made completely of elastic material, the tensioner may still include elastic elastic portions 56 and/or 58. In such embodiments, some or all of the elastic portions 56, 58 may be formed separately and attached to the tensioner 50. Alternatively, the elastic portions 56, 58 may be formed integrally with the tensioner 50, such that the tensioner 50 and elastic portions 56, 58 are all a single continuous piece.

The shape and configuration of the tensioner 50 also may vary considerably. FIGS. 3A, 3B, 4A, 4B, 5A, and 5B show three exemplary embodiments of a tensioner 50. FIGS. 3A, 4A, and 5A show top views, with the tensioner 50 oriented as shown in FIG. 1. FIGS. 3B, 4B, and 5B show side views. In addition, FIGS. 3A, 3B, 4A, 4B, 5A, and 5B all include the adjustor 52. Although the adjustor 52 is not part of the tensioner 50 per se, it is included for clarity.

Each of the tensioners 50 illustrated in FIGS. 3A, 3B, 4A, 4B, 5A, and 5B show a relatively simple block structure, with a contact area 54 where the tensioner 50 engages the chain 40, and tongue of material that rests beneath the chain 40 when the tensioner 50 is in place. However, this is exemplary only, and other configurations may be equally suitable.

For example, FIGS. 3A and 3B show a tensioner 50 with a flat contact area 54. In contrast, FIGS. 4A and 4B show a tensioner 50 with a curved contact area 54. FIGS. 5A and 5B, as previously noted, show a tensioner 50 with an elastic portion 56 in the form of a cylindrical plug.

Other variations in the shape, size, and configuration of the tensioner 50 also may be equally suitable.

Returning to FIG. 1, the tensioner 50 may include an adjustor 52 for adjusting the position of the tensioner 50, and consequently for adjusting the path length of the chain 40 and the tension therein.

In the exemplary embodiment shown, the tensioner 50 is adapted to be adjusted by translation, that is, by linear movement, rather than to pivot about an axis. The exemplary adjustor 52 shown corresponds to a rotatable bolt. In the embodiment illustrated in FIG. 1, rotating the bolt in one direction drives the tensioner 50 downwards, while rotating the bolt in the opposite direction pulls the tensioner 50 upwards. These motions lengthen or shorten respectively the path length of the chain 40, and therefore increase or decrease respectively the tension in the chain 40.

FIGS. 2A and 2B show the exemplary sprocket and chain mechanism 10 of FIG. 1 with the tensioner 50 in two different positions. In FIG. 2A, the adjustor 52 is set so that the tensioner 50 is relatively far down. By use of the adjustor 52, the tensioner 50 is made to move, which changes the path length of the chain 40, and thus changes the tension in the chain 40.

However, this arrangement is exemplary only. Other arrangements for the tensioner 50, other types and arrangements of the adjustor 52, and other motions than those illustrated may be equally suitable.

Returning to FIG. 1, the chain and sprocket mechanism 10 may include a case 60 surrounding the sprockets 20 and 30, chain 40, and/or tensioner 50. In certain embodiments, the case 60 may prevent damage to the mechanism 10, and also may prevent items from being damaged by the mechanism 10. However, the use of a case 60 as illustrated is exemplary only, and embodiments having other cases 60 , or no case 60 at all, may be equally suitable.

The chain and sprocket mechanism 10 also may include a support 62 for the tensioner 50. The support 62 may, for example, restrict unwanted motion of the tensioner 50, and/or may facilitate its smooth and convenient adjustment.

As illustrated, the support 62 includes a groove 64 in the surface of the case 60 that accepts the tensioner 50 therein, with rails 66 on either side to prevent lateral motion of the tensioner 50. Thus, as shown, the tensioner 50 can translate only up or down, as determined by the position of the adjustor 52.

However, this is exemplary only. Other supports 62, or no support 62 at all, may be equally suitable. In addition, although in the embodiment illustrated in FIG. 1, the support 62 is fixed to the case 60, this is exemplary only.

The tensioner 50, the support 62, and the adjustor 52 are collectively referred to as a tensioning mechanism 50, 52, 62.

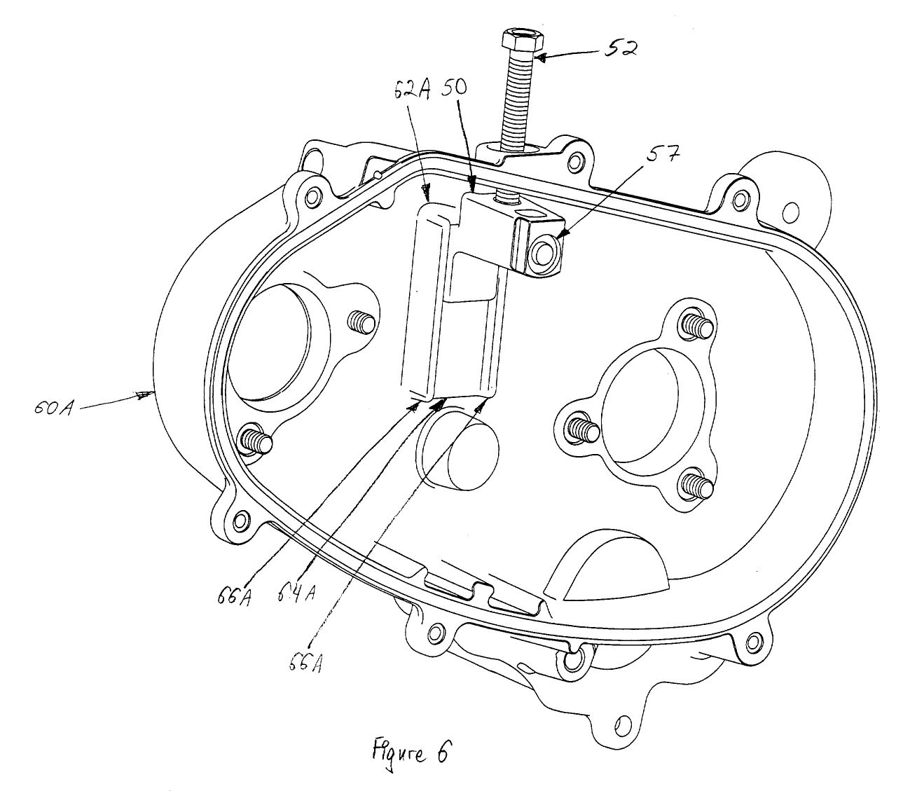

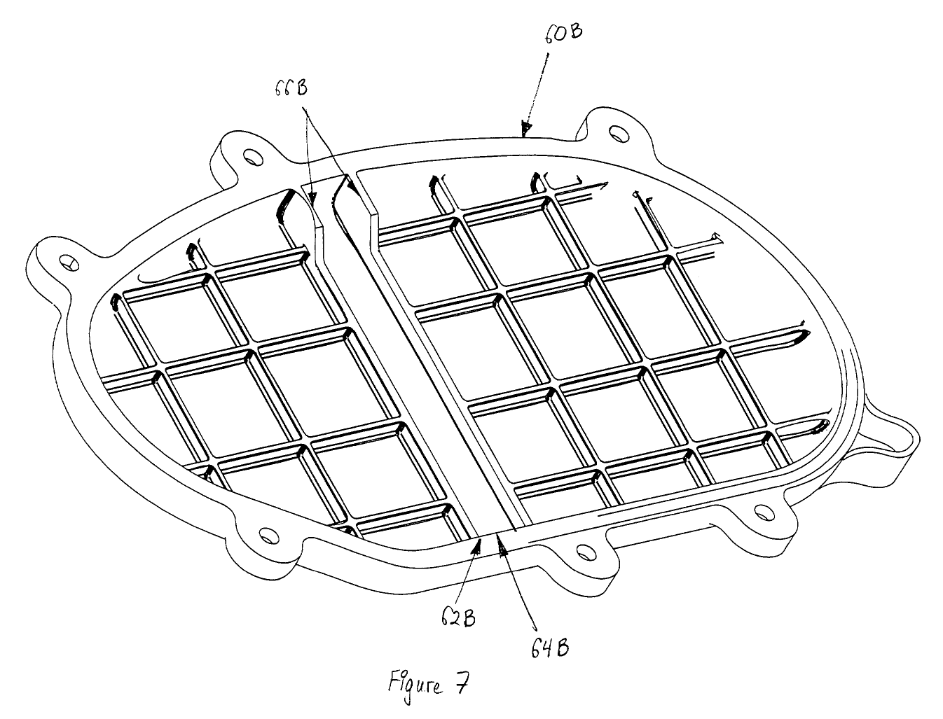

FIGS. 6 and 7 show another exemplary embodiment of a tensioning mechanism 50, 52, 62 in accordance with the principles of the claimed invention.

FIG. 6 shows a first case part 60A of a case 60, while FIG. 7 shows a second case part 60B of the case 60. The first and second case parts 60A and 60B engage one another to form a whole case 60.

As shown in FIG. 6, the first support part 62A on the first case part 60A includes a first groove part 64A, with first rail parts 66A on either side of it. The tensioner 50 is shown disposed therein, with the adjustor 52 engaged with the tensioner 50.

Similarly, as shown in FIG. 7, the second support part 62B on the second case part 60A includes a second groove part 64A, with second rail parts 66A on either side of it.

When the first and second case parts 60A and 60B are engaged to form a whole case 60, the first and second support parts 62A and 62B cooperate to engage the tensioner 50 so as to support it. The second groove part 64B and the second rail parts 66B engage the tensioner 50 in a fashion similar to that in which the first groove part 64A and the first rail parts 66A engage the tensioner 50 as shown in FIG. 6.

Thus, in the embodiment illustrated in FIGS. 6 and 7, the support 62 and the individual components that form all exist at least in part on both the first and second parts 60A and 60B of the case 60.

However, this arrangement is exemplary only. In cases 60 having two parts, the support 62 or parts thereof may be disposed on either or both of the parts. In cases 60 having more than two parts, the support 62 or parts thereof may be disposed on any or all of the parts.

Likewise, although the parts 62A and 62B of the support 62 are shown as integrally formed with the parts 60A and 60B of the case 60, this also is exemplary only. In certain embodiments, it may be equally suitable for the support 62 to be formed separately and attached to the case 60, or not to be attached to the case 60 at all.

The arrangement of the case 60 and the support 62 thus may vary considerably depending upon the particular embodiment. However, regardless of the details of the overall structure, the tensioner 50 supported by the support 62 moves by translation in order to apply tension to the chain 40. In certain embodiments, the tensioner 50 may be entirely restricted from other movement, so that it can only move by translation. Thus, for certain embodiments, the tensioning mechanism 50, 52, 62 may be functional without the use of pivots.

In certain embodiments, the tensioning mechanism 50, 52, 62 may be functional without the need for elastic structures, such as springs.

In certain embodiments, the tensioning mechanism 50, 52, 62 may be functional without the need for rollers.

Thus in some embodiments, the tensioning mechanism 50, 52, 62 may be constructed in a very simple fashion, without complex mechanical assemblies, or large numbers of moving parts.

As illustrated in FIGS. 5A and 5B, some or all of the elastic portions 56, 58 in the tensioner 50 may be adapted to enable a good fit of the tensioner 50 within the support 62. For example, in the embodiment illustrated in FIGS. 5A and 5B, elastic portions 58 in the form of o-rings are arranged on two sides of the tensioner 50. The elastic portions 58 as illustrated help to keep the tensioner 50 seated within the support 62, in addition to inhibiting the transmission of vibrations.

However, such an arrangement is exemplary only.

As noted earlier, embodiments of the tensioner 50 may exclude elastic portions 56, 58 altogether. In addition, it is not required that any elastic portions 56, 58 that are present be configured and disposed to also act as fittings for enabling a good fit of the tensioner 50 in the support.

Furthermore, although in the exemplary embodiment of FIGS. 5A and 5B elastic portions 58 are configured and arranged to serve as fittings, the tensioner 50 and/or other components of the tensioning mechanism 50, 52, 62 may include other fittings in addition to or instead of elastic portions. A wide variety of other fittings may be equally suitable. In addition, in some embodiments it may be equally suitable to dispose fittings on the support 62, in addition to or instead of arranging fittings on the tensioner 50. Furthermore, in certain embodiments, it may be suitable to avoid the use of fittings altogether.

The above specification, examples and data provide a complete description of the manufacture and use of the composition of the invention. Since many embodiments of the invention can be made without departing from the spirit and scope of the invention, the invention resides in the claims hereinafter appended.

1. A chain and sprocket mechanism, comprising:
a first sprocket;
a second sprocket;
a chain engaged with said first and second sprockets, such that rotating said first sprocket moves said second sprocket via said chain; and
a tensioner engaged with said chain between said first and second sprockets so as to apply tension thereto;
wherein said tensioner comprises an elastic material.

2. A chain and sprocket mechanism according to claim 1, wherein:
said tensioner comprises an elastic portion, said elastic portion comprising said elastic material.

3. A chain and sprocket mechanism according to claim 1, wherein:
said elastic material comprises rubber.

4. A chain and sprocket mechanism according to claim 1, wherein:
said elastic material is adapted to absorb vibrations in said chain.

5. A chain and sprocket mechanism according to claim 1, wherein:
said tensioner is adjustable so as to vary a tension in said chain.

6. A chain and sprocket mechanism according to claim 5, wherein:
said tensioner is adapted to be translated so as to vary said tension in said chain.

7. A tensioner for tensioning a chain engaged with first and second sprockets,
said tensioner being adapted to engage a chain so as to apply tension thereto, said tensioner comprising an elastic material.

8. A tensioner according to claim 7, wherein:
said tensioner comprises an elastic portion, said elastic portion comprising said elastic material.

9. A tensioner according to claim 7, wherein:
said elastic material comprises rubber.

10. A tensioner according to claim 7, wherein:
said elastic material is adapted to absorb vibrations in said chain.

11. A tensioner according to claim 7, wherein:
said elastic material is adapted to absorb vibrations in said chain.

12. A method for tensioning a chain engaged with first and second sprockets, comprising the steps of:
disposing a tensioner in engagement with said chain between said first and second sprockets, so as to apply tension thereto;
wherein said tensioner comprises an elastic material.

13. A method according to claim 12, wherein:
said tensioner comprises an elastic portion, said elastic portion comprising said elastic material.

14. A method according to claim 12, wherein:
said elastic material comprises rubber.

15. A method according to claim 12, wherein:
said elastic material is adapted to absorb vibrations in said chain.

16. A method according to claim 12, further comprising the step of:
translating said tensioner so as to vary a tension in said chain.

17. A method of reducing vibration in a chain and sprocket mechanism comprising a chain engaged with first and second sprockets, the method comprising the steps of:
disposing a tensioner in engagement with said chain between said first and second sprockets, so as to apply tension thereto;
wherein said tensioner comprises an elastic material adapted to absorb vibrations in said chain.

18. A method according to claim 17, wherein:
said tensioner comprises an elastic portion, said elastic portion comprising said elastic material.

19. A method according to claim 17, wherein:
said elastic material comprises rubber.

20. A method according to claim 17, wherein:
said elastic material is adapted to absorb vibrations in said chain.

21. A method according to claim 17, further comprising the step of:
translating said tensioner so as to vary a tension in said chain.

22. A tensioning mechanism for tensioning a chain engaged with first and second sprockets, comprising:
a tensioner adapted to engage a chain so as to apply tension thereto;
a support engaged with said tensioner so as to support said tensioner, said support restricting a motion of said tensioner to a translation;
a tension adjustor engaged with said tensioner, said tension adjustor being moveable so as to cause a translation of said tensioner.

23. A tensioning mechanism according to claim 22, wherein:
said support comprises at least one groove, said tensioner being disposed therein.

24. A tensioning mechanism according to claim 22, wherein:
said support comprises at least two rails, said tensioner being disposed therebetween.

25. A tensioning mechanism according to claim 22, further comprising a case in at least one part, said support being connected with said case.

26. A tensioning mechanism according to claim 25, wherein said support is integral with said case.

27. A tensioning mechanism according to claim 22, wherein said tensioner comprises elastic material.

28. A tensioning mechanism according to claim 22, wherein:
said tensioner comprises an elastic portion, said elastic portion comprising said elastic material.

29. A tensioning mechanism according to claim 22, wherein:
said elastic material comprises rubber.

30. A tensioning mechanism according to claim 22, said tensioner is adapted exclusively for translation.

31. A tensioning mechanism according to claim 22, said tensioning mechanism being functional without elastic structures.

32. A tensioning mechanism according to claim 22, said tensioning member being functional without rollers.

33. A tensioning mechanism according to claim 28, wherein said elastic portion comprises a plug engaged with said adjustor.

34. A tensioning mechanism according to claim 28, wherein said elastic portion comprises an o-ring engaged with said support.
